(19) United States
(12) Patent Application Publication
(10) Pub. No.: US 2024/0110501 A1
(43) Pub. Date: Apr. 4, 2024

(54) SHIELDING PART, IN PARTICULAR HEAT SHIELD

(71) Applicants: Elringklinger Automotive Manufacturing, Inc. Inc., Southfield, MI (US); ElringKlinger AG, Dettingen-Erms (DE)

(72) Inventors: Douglas Clemons, Brighton, MI (US); Gunnar Schaefer, Canton, MI (US)

(21) Appl. No.: 18/553,475

(22) PCT Filed: May 31, 2021
(86) PCT No.: PCT/EP2021/064563

§ 371 Date: Sep. 29, 2023

Related U.S. Application Data
(60) Provisional application No. 63/168,050, filed on Mar. 30, 2021.

(51) Int. Cl. F01N 13/14

(52) U.S. Cl. CPC F01N 13/148

(57) ABSTRACT

A shielding part, in particular a heat shield, having at least one shielding layer with at least one fastening opening through which a fastener can be inserted, wherein the fastener is coupled to the shielding layer via at least one decoupling element with regard to axial and/or radial force transmission to the shielding layer and from the shielding layer to the fastener, wherein the at least one decoupling element is composed of a metal wire and cooperates in a surrounding region around the fastening opening on opposite outer sides of the shielding layer and/or with a frontal hole edge of the fastening opening of the shielding layer, wherein at least one intermediate layer is positioned between the decoupling element and the outer sides of the shielding layer and between the decoupling element and the frontal hole edge of the fastening opening of the shielding layer.

### FIELD OF THE INVENTION

The invention relates to a shielding part, in particular a heat shield.

### DESCRIPTION OF THE PRIOR ART

U.S. Pat. No. 7,784,585 B2 describes a shielding part with a decoupling element made of a steel wire structure. The steel wire structure is comprised of one piece and is seated in a fastening recess of the shielding part. It respectively contacts the outer sides of the shielding part in a vicinity of a fastening recess.

A shielding part of this generic type is known from US 2011/0220676 A1.

The shielding parts known from the prior art use a steel wire structure, e.g. a steel wire mesh, as a decoupling element, which is embodied to be more deformable and flexible than a solid steel component. Such a steel wire structure, which is inserted into a fastening opening of the shielding part, e.g. by means of a riveting process, is seated in the fastening recess of the shielding part after the riveting process, radially free of play and axially free of play.

If a brand-new shielding part of this kind is then placed against a vibrating fastening partner component, vibration and/or thermal expansion can cause the hole edge, in particular the frontal hole edge, to compress the decoupling element a little radially so that over time a permanent deformation of the decoupling element occurs in the radial direction, resulting in an undesirable radial play between the shielding part and the decoupling element. With continued operation, an undesirable abrasion can thus occur due to relative movement of the shielding part relative to the steel wire structure. This can result in an undesirable corrosion in the contact region between the steel wire structure and the shielding part. This is particularly the case if the shielding part is made of a softer material, e.g. aluminum or a metal coated with aluminum.

The object of the invention, therefore, is to modify a shielding part of this generic type in such a way that the shielding part exhibits low wear during operation and has a low susceptibility to corrosion.

### SUMMARY OF THE INVENTION

A shielding part according to the invention, in particular a heat shield according to the invention, has at least one shielding layer with at least one fastening opening through which a fastener for fastening the shielding part to a fastening partner part can be inserted. The fastener is coupled to the shielding layer with respect to axial or radial force transmission both to the shielding layer and from the shielding layer to the fastener via at least one decoupling element, wherein the at least one decoupling element is made of a metal wire and cooperates with a surrounding region around the fastening opening on opposite outer sides of the shielding layer and/or with a frontal hole edge of the fastening opening of the shielding layer. According to the invention, such a shielding part is characterized in that at least one intermediate layer is positioned between the decoupling element and the outer sides of the shielding layer and between the decoupling element and the frontal hole edge of the fastening opening of the shielding layer.

Such an intermediate layer reliably prevents relative movements between the decoupling element and the shielding layer, which are due to vibration or thermal expansion of the shielding layer, from causing abrasion of the material of the shielding layer, even with longer operation of the shielding part.

The intermediate layer functions like armor and keeps relative movements of the decoupling element away from the shielding layer of the shielding part. In particular, with a shielding part according to the invention, surface coatings, for example corrosion-reducing surface coatings of the shielding layer, are also protected from unwanted abrasion.

In a particular embodiment, the intermediate layer is made of the same material as the metal wire of the decoupling element. Alternatively, it is advisable for the intermediate layer to be made of a material that is harder than the material of the metal wire of the decoupling element. This helps to prevent the intermediate layer from wearing down or wearing through, even with longer operation and the prolonged occurrence of small or very small relative movements between the intermediate layer and the metal wire of the decoupling element.

In another embodiment of the invention, the intermediate layer is supported without radial or axial play with respect to the shielding layer. In particular, the intermediate layer is thus positioned immovably, especially press-fitted, with respect to the hole edge of the fastening opening of the shielding layer, thus preventing an unwanted relative movement between the intermediate layer and the shielding layer due to vibrations that are introduced into the shielding part.

According to another embodiment of the invention, the intermediate layer is composed of two half-sleeves inserted axially into one another with a snug fit, wherein each half-sleeve has an axially extending axial section for the clamping cooperation with the other half-sleeve and a circumferential shroud extending radially away from the axial section, wherein one of the axial sections rests radially against the inside of the frontal hole edge and the shrouds of two half-sleeves rest against the outer sides of the shielding layer. An intermediate layer embodied in this way can be manufactured and joined in a simple manner from easily producible individual parts, wherein a reliable retention of the intermediate layer on the shielding layer is ensured by simple means.

The at least one decoupling element is advantageously embodied in one piece and has an insertion opening for the fastener.

In a modification of the invention, it is advantageous to position a sleeve body in the insertion opening of the decoupling element, wherein the sleeve body is embodied as a solid body that is more resistant to deformation than the decoupling element. Such a sleeve body functions, for example, as a spacer and prevents the decoupling element from being axially compressed to an impermissibly high degree when the shielding part is fastened with screws. The sleeve body can be embodied, for example, as a sleeve with an L-shaped cross-section and a circumferential collar or as a collar sleeve with a C-shaped cross-section and two circumferential collars, wherein a decoupling element or part of the one-piece decoupling element is positioned between the intermediate layer and the respective shrouds of the sleeve.

For a particularly strong connection of the half-sleeves that form the intermediate layer, it is advantageous to crimp the first and second half-sleeves in a connecting region so that a form-fitting or frictional engagement is produced between the half-sleeves in an axial direction.

The intermediate layer and the metal wire of the decoupling element are advantageously made of steel, in particular stainless steel.

In another embodiment, the intermediate layer is embodied as a single-layer circumferential bead around the hole edge.

In a preassembly stage, the intermediate layer can advantageously be preassembled with a radial play of a few tenths of a millimeter and with an axial play of a few tenths of a millimeter with respect to the fastening opening in the shielding layer and can be deformed by means of a radial expansion and axial squeezing of the intermediate layer in such a way that the intermediate layer rests without play, preferably in a clamping fashion, against the frontal hole edge and the outer sides of the shielding layer in the area of the fastening opening.

An outer diameter D₁ of the intermediate layer is advantageously selected to be greater than an outer diameter D₂ of the decoupling element. This means that even if the decoupling element is radially offset relative to the shielding layer, there is no contact between the metal wire of the decoupling element and an outer side of the shielding layer.

A material thickness of 0.2 mm to 0.6 mm, in particular 0.3 mm to 0.5 mm, has proven to be a suitable material thickness for the intermediate layer.

Advantageously, the decoupling element is a metal wire structure and is embodied, for example, as a metal wire tangle, metal wire knit, metal wire mesh, metal wire crochet, or metal wire fabric. It can, for example, be embodied of one piece surrounding the outer sides and the frontal hole edge. In such a one-piece embodiment, the decoupling element is inserted through the fastening opening of the shielding layer, which is provided with the intermediate layer, and compressed in relation to the intermediate layer in the manner of a rivet.

In another embodiment, the decoupling element can be embodied of two or more parts comprising two or more metal wire structures, wherein for example a first metal wire structure is placed against the first shroud of the intermediate layer and a second metal wire structure is placed against the second shroud of the intermediate layer. Such an embodiment has the advantage that easily prefabricated metal wire structures, for example a metal wire ring structure, can be used.

According to another embodiment of the invention, the decoupling element is prestressed in the axial direction A of the fastening opening so that the shielding layer together with the intermediate layer cooperates with the decoupling element in an axially clamped manner.

In another embodiment of the invention, the intermediate layer is composed of a half-sleeve element and a disc element, wherein in particular the half-sleeve element forms a first shroud and the disc element forms a second shroud.

In another advantageous embodiment, the intermediate layer is composed of two structurally identical half-sleeve elements. The half-sleeve elements each have axial sections which, in the assembled state, can contact each other in the fastening opening of the shielding layer or can form a gap with an axial span t between themselves. The axial span t is preferably smaller than a thickness d of the shielding layer in the surrounding region around the fastening opening.

The provision of the intermediate layer according to the invention also makes it possible to achieve higher contact pressures of the metal wire structures against the outer sides of the intermediate layer without the fear of unacceptable wear in the vicinity of the fastening opening of the shielding layer. Advantageously, providing different strengths of axial prestressing makes it possible to adjust the vibration behavior and/or the damping behavior of the decoupling element by varying the axial prestressing force.

### BRIEF DESCRIPTION OF THE DRAWINGS

The invention will be explained in greater detail below by way of example with reference to the figures. In the drawings:

FIG. 1: shows a perspective view of a shielding part according to the invention fastened to a hot part of an exhaust system of a motor vehicle;

FIG. 2: shows a schematic sectional view along section line A-A from FIG. 1 of a first embodiment of the shielding part according to the invention with a one-piece decoupling element;

FIG. 3: shows a schematic sectional view along section line A-A (FIG. 1) of a second embodiment of the shielding part according to the invention with a decoupling element having several individual parts;

FIG. 4: shows an enlarged schematic sectional view along section line A-A (FIG. 1) through a two-part embodiment of the intermediate layer;

FIG. 5: shows an enlarged schematic sectional view along section line A-A (FIG. 1) through a second embodiment of the intermediate layer in a one-piece design;

FIG. 6: shows an enlarged schematic sectional view along section line A-A (FIG. 1) through another embodiment of the intermediate layer in a two-part design; and

FIG. 7: shows an enlarged schematic sectional view along section line A-A (FIG. 1) through another embodiment of the intermediate layer in a two-part design.

### DETAILED DESCRIPTION OF THE PREFERRED EMBODIMENTS

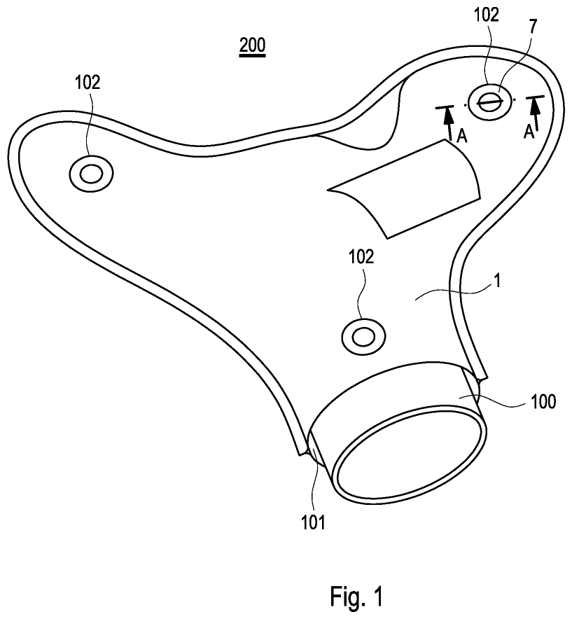

FIG. 1 shows a perspective view of a shielding part 1 according to the invention, which when used as intended is provided for shielding heat and/or noise, which that is emitted by another component 100, in relation to the surrounding area. As shown in FIG. 1, the other component 100 is, for example, a hot part of an exhaust system of a motor vehicle, for example a part of an exhaust manifold. Furthermore, the other component 100 can be any component or group of components of a motor vehicle that emits objectionable heat and/or noise into the surrounding area 200. The shielding part 1 preferably has a three-dimensionally deformed spatial shape and is preferably shaped to fit a contour of the other component 100 so as to form an intermediate space 101. To form the intermediate space 101, the shielding part 1 is preferably fastened spaced apart from the other component 100 by means of a plurality of fastening points 102. Alternatively, the shielding part 1 can also be fastened by means of suitably selected fastening points 102 to a component or group of components in the surrounding area 200 that are to be protected, for example from the effects of heat. For example, such a component in the surrounding area 200 can be a body structure of a motor vehicle. Such a component or group of components in the surrounding area 200 can also be one or more assemblies, for example in the engine compartment or underbody area of a motor vehicle, that are to be protected from the effects of temperature and/or heat.

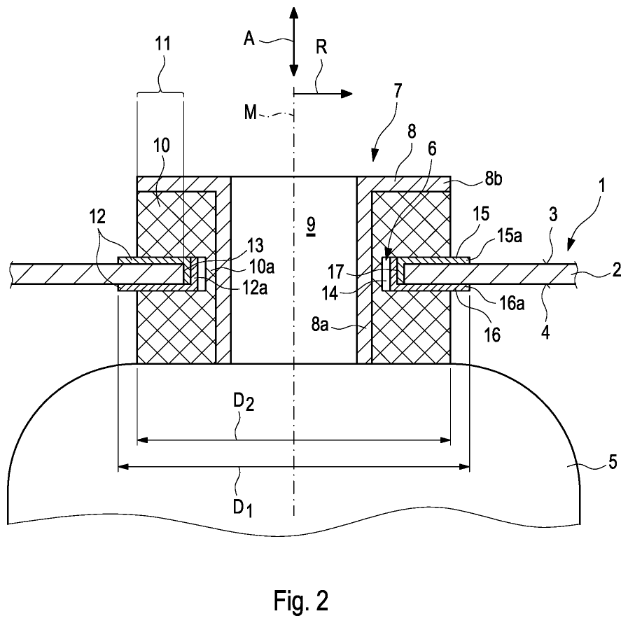

Such a shielding part 1 is subject to powerful temperature fluctuations during operation, particularly if the shielding part 1 is positioned in the region of an exhaust system of a motor vehicle. Powerful temperature fluctuations during operation of the shielding part 1 cause relatively powerful expansions/contractions of the material of the shielding part 1, which can cause distances between the fastening points 102 to change by a non-negligible amount. In order to absorb the relative movements between a shielding part 1 and fastening points of the other component 100, e.g. due to thermal strain or mechanical vibrations, decoupling devices 7 are usually provided at the fastening points 102, which devices are capable of compensating for temperature-induced material expansions thus greatly reducing or even preventing an occurrence of thermally induced stresses in the shielding part 1. The decoupling devices 7 also have the task of and are used for decoupling the shielding part 1 from the other component 100 with respect to mechanical vibrations. Such mechanical vibrations can be caused, for example, by engine vibrations of the engine of a motor vehicle or can be introduced into the shielding part 1 in other ways, for example by vibrations in the body area of a motor vehicle. The present invention concerns an embodiment of the shielding part in the region of a fastening point 102 and will be explained in greater detail below with reference to FIGS. 2 to 7, wherein FIGS. 2 to 7 are enlarged schematic cross-sectional views along line A-A in FIG. 1 through a fastening point 102.

A shielding part 1 according to the invention (FIG. 2) has at least one single-layer shielding layer 2 for shielding heat or noise. The shielding layer 2 is made from a metal sheet, for example a steel or aluminum sheet, and has a first outer side 3 and a second outer side 4. If necessary, the shielding layer 2 is provided with a corrosion protection layer (not shown) on its outer sides 3, 4. For fastening the shielding part 1 to a fastening partner part 5, for example a hot part such as a component that carries exhaust gas, a decoupling device 7 is provided in the vicinity of a fastening opening 6 of the shielding layer 2. The decoupling device 7 has a sleeve body 8 that has an insertion opening 9 for a fastener (not shown), for example a screw or bolt. The fastener, which can be inserted through the insertion opening 9, is coupled to the shielding layer 2 via the sleeve body 8 and at least one decoupling element 10 with regard to an axial and/or radial force transmission to the shielding layer 2 and from the shielding layer 2 to the fastener.

For the purposes of the further description, a central axis M is defined, which is advantageously a central axis of the fastening opening 6. A direction perpendicular to the center axis M is defined as the radial direction R. A direction parallel to the center axis M or coincident with the center axis M is defined as the axial direction A.

The decoupling element 10 that is supported on the shielding layer 2 in the axial direction A indirectly interacts with the opposite outer sides 3, 4 in a surrounding region 11 around the fastening opening 6, wherein an intermediate layer 12 is positioned between the decoupling element 10 and the respective first outer side 3 or the second outer side 4. The intermediate layer 12 surrounds a free frontal hole edge 13 with a frontal edge region 12a of the intermediate layer 12. When the sleeve body 8 together with the decoupling element 10 is displaced in a radial direction R, for example from a central position shown in FIG. 1, a bridging region 10a of the decoupling element 10 indirectly cooperates with the frontal hole edge 13 in a supporting manner via a frontal edge region 12a of the intermediate layer 12.

This ensures that the decoupling element 10 does not come into direct, i.e. immediate, contact with the shielding layer 2 at any point so that in the event of vibrations occurring between the decoupling element 10 and the shielding layer 2, a direct immediate frictional contact between the decoupling element 10 and the shielding layer 2 is avoided.

The decoupling element 10 is preferably a metal wire structure, for example, a pressed metal wire tangle, metal wire crochet, metal wire mesh, metal wire knit, or metal wire fabric.

The sleeve body 8 has a sleeve core 8a and, opposite the fastening partner part 5, a collar 8b extending radially outward from the sleeve core 8a. The intermediate layer 12 is preferably supported without play relative to the shielding layer 2 in the axial direction A and radial direction R with respect to the fastening opening 6. In this case, the intermediate layer 12, especially including its frontal edge region 12a, is preferably made of the same material as the metal wire of the decoupling element 10 and consists, for example, of a steel or stainless steel. Also preferably, the intermediate layer 12 including its frontal edge region 12a can also be made of a material with a greater hardness than the material of the metal wire. The sleeve body 8 is made of a solid metal material so that the sleeve body 8 is embodied to be more resistant to deformation than the decoupling element 10.

In the embodiment example according to FIG. 1, the decoupling element 10 and its bridging region 10a are embodied of one piece and rest indirectly against both the first outer side 3 and the second outer side 4 with the interposition of the intermediate layer 12. In addition, when the decoupling device 7 is displaced relative to the shielding layer 2, the transition region 10a of the decoupling element 10 rests against the frontal edge region 12a of the intermediate layer 12 in the radial direction R. The decoupling device 7 is thus also indirectly supported on the shielding layer 1 in radial direction R. The frontal edge region 12a of the intermediate layer 12 prevents a direct contact between the frontal hole edge 13 and the decoupling element 10.

In the embodiment shown in FIG. 1, the intermediate layer 12 and its frontal edge region 12a are composed of a first half-sleeve 15 and a second half-sleeve 16. The two half-sleeves 15, 16 form a first shroud 15a and a second shroud 16a and have a connecting region 17. In the connecting region 17, the first half-sleeve 15 and second half-sleeve 16 are connected to each other by frictional clamping or in a form-fitting manner, for example by means of a press-fit.

The shrouds 15a, 16a of the intermediate layer 12 have an outer diameter D₁. The decoupling element 10 has an outer diameter D₂, wherein the outer diameter D₁ of the intermediate layer 10 is preferably greater than the outer diameter D₂ of the decoupling element 10. A material thickness of 0.2 mm to 0.6 mm, in particular 0.2 mm to 0.5 mm, is advantageous as the material thickness for the intermediate layer.

The interposition of the intermediate layer 12 between the decoupling element 10 and the at least one shielding layer 2 according to the invention reliably ensures that in the event of a relative movement of the decoupling device 7, in particular of the decoupling element 10 relative to the shielding layer 2, the decoupling element 10 moves exclusively relative to the intermediate layer 12. A direct frictional contact between the decoupling element 10 and the shielding layer 2 is thus prevented. For this purpose, the intermediate layer 12 is positioned in a play-free, in particular play-free clamping manner with respect to the shielding layer 2, both in the axial direction A and in the radial direction R. As a result, the shielding layer 2, which can optionally have sensitive surface coatings or be made of a material that is softer than the decoupling element 10, can be successfully protected from undesirable wear.

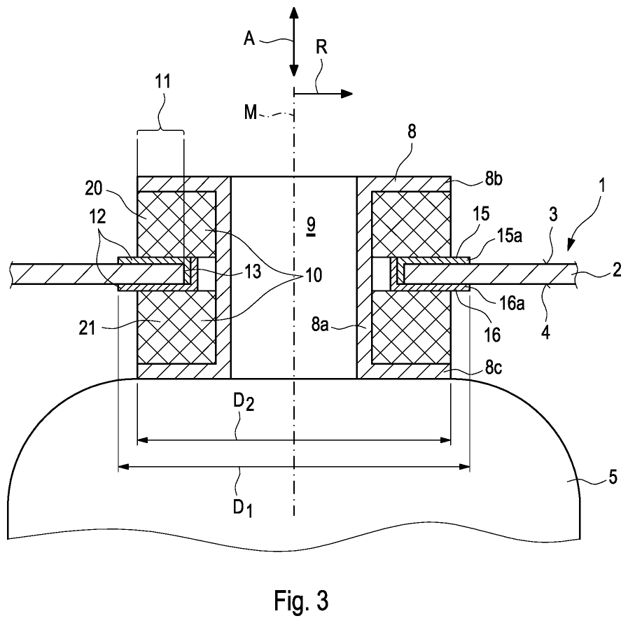

Another embodiment of the shielding element 1 according to the invention is shown in FIG. 3. By contrast with the embodiment according to FIG. 1, the decoupling element 10 is embodied of two parts, a first metal wire ring structure 20 and a second metal wire ring structure 21, wherein the first metal wire ring structure is positioned on the side of the first outer side 3 of the shielding layer 2 and surrounds the sleeve core 8a. The second metal wire ring structure 21 is positioned on the side of the second outer side 4 of the shielding layer 2 and surrounds the sleeve core 8a, with the intermediate layer 12 positioned between the metal wire ring structures 20, 21 and the shielding layer 2. Also in the embodiment according to FIG. 3, the intermediate layer 12 is composed of the first half-sleeve 15 and the second half-sleeve 16, which respectively form the first shroud 15a and second shroud 16a. The shrouds 15a, 16a are positioned between the shielding layer 2 and the metal wire ring structure 20 or 21. As in the embodiment according to FIG. 2, in the embodiment according to FIG. 3 the intermediate layer 12 is positioned, particularly in a clamping and/or form-fitting fashion, so that it is play-free both in the axial direction A and in the radial direction R and immobile with respect to the shielding layer 2. This results in a defined movement between the metal wire ring structures 20, 21 and the intermediate layer 12 in the event of a relative movement of the decoupling device 7 relative to the shielding layer 2 so that a relative movement of components on the first outer side 3 or the second outer side 4 of the shielding layer 2 is avoided. This ensures that a shielding layer 2 made of a soft material such as aluminum is subject to no frictional wear at least reduced frictional wear. Furthermore, any corrosion protection layers, e.g. an aluminum layer or a zinc layer, that are present on the outer sides 3, 4 are reliably protected from wear thanks to the relative movement between the metal wire ring structures 20 and 21 and the intermediate layer 12.

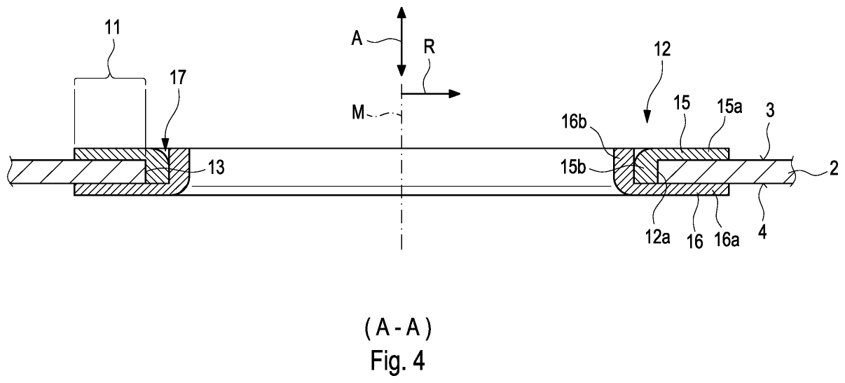

Another difference from the embodiment according to FIG. 2 is that the sleeve body 8 has a second collar 8c, which, in the assembled state of the shielding part 1, rests against the fastening partner part 5 and extends radially outward away from the sleeve core 8a. Such a sleeve body 8 can be embodied of one piece (see FIG. 4) or can be embodied of several parts such as half-sleeves.

The intermediate layer 12 composed of the first half-sleeve 15 and second half-sleeve 16 will be explained in greater detail below with reference to FIG. 4. In this case, the first half-sleeve 15 forms the first shroud 15a. The second half-sleeve 16 forms the second shroud 16a. The half-sleeves 15, 16 also have a first axial section 15b and a second axial section 16b. The first axial section 15b of the first half-sleeve 15 extends from the first shroud 15a toward the second shroud 16a of the second half-sleeve 16 viewed in the axial direction A. Radially inside the first axial section 15b, the second axial section 16b of the second half-sleeve 16 extends from the second shroud 16a toward the first shroud 15a viewed in the axial direction A.

A radial outer side of the first axial section 15b forms the frontal edge region 12a of the intermediate layer 12. The second axial section 16b of the second half-sleeve 16 is inserted into the first half-sleeve 15. The axial sections 15b, 16b of the half-sleeves 15, 16 thereby form the connecting region 17 of the half-sleeves 15, 16. The connecting region 17 can be embodied as a press fit or as a loose fit. To achieve, for example, a form-fitting connection of the half-sleeves 15, 16 in the axial direction A, the first axial section 15b is embodied as rounded, for example, so that a form-fitting connection between the half-sleeves 15, 16 can be produced by a widening of the second axial section 16b at the end—viewed outwardly in the radial direction R. Such a widening can be advantageously carried out by means of a conically shaped punch that presses the second axial section 16b radially outward snugly against the contour of the first axial section 15b.

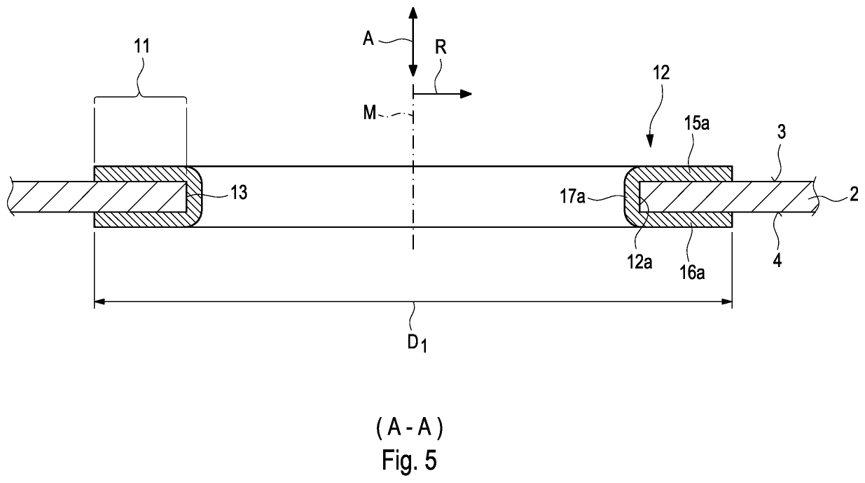

In another embodiment of the invention according to FIG. 5, the intermediate layer 12 is embodied of one piece comprising a metal sheet that is formed, for example, as a ring with a spatial shape that is C-shaped in cross-section (see FIG. 5). Such an intermediate layer 12 has the first shroud 15a as the first leg of the C-shaped cross-section and has the second shroud 16a as the second leg of the C-shaped cross-section. The first shroud 15a and the second shroud 16a are integrally connected to a transition section 17a. On its side facing outward viewed in the radial direction R, the transition section 17a forms the frontal edge region 12a of the intermediate layer 12. In this embodiment, the intermediate layer 12 constitutes a circumferential bead surrounding the fastening opening 6 of the shielding layer 2.

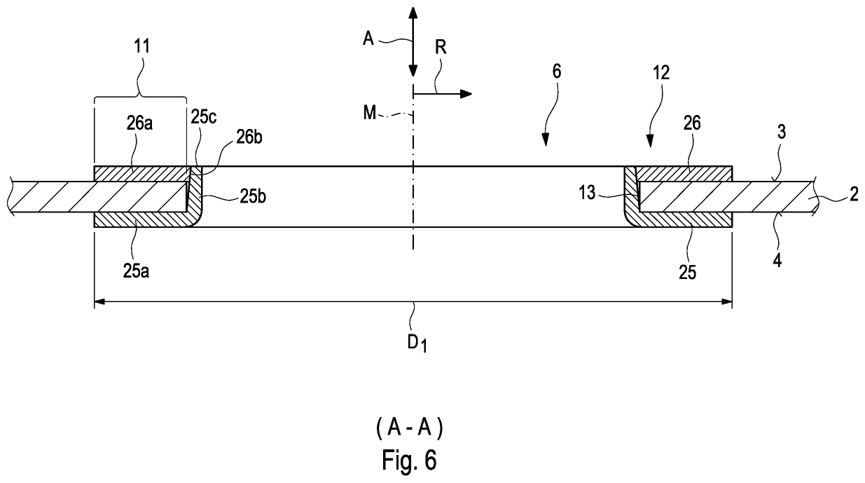

In another embodiment of the invention according to FIG. 6, the intermediate layer 12 is embodied of two parts, a half-sleeve element 25 and a disc element 26 in the shape of an annular disc. The half-sleeve element 25 forms a first shroud 25a and has an axial section 25b that extends through the fastening opening 6 of the shielding layer 2 in the axial direction A. The disc element 26 is positioned opposite the first shroud 25a, with the disc element 26 forming a second shroud 26a. In the region of a free end 25c of the axial section 25b of the half-sleeve element 25, the half-sleeve element 25 is preferably connected to a radially inner edge 26b of the disk element 26 so that the intermediate layer 12 is positioned so that it is free of play or almost free of play in the axial direction A and/or in the radial direction R with respect to the shielding layer 2. Thus in this embodiment as well, the surrounding region 11 and the frontal hole edge 13 are effectively protected by the intermediate layer 12.

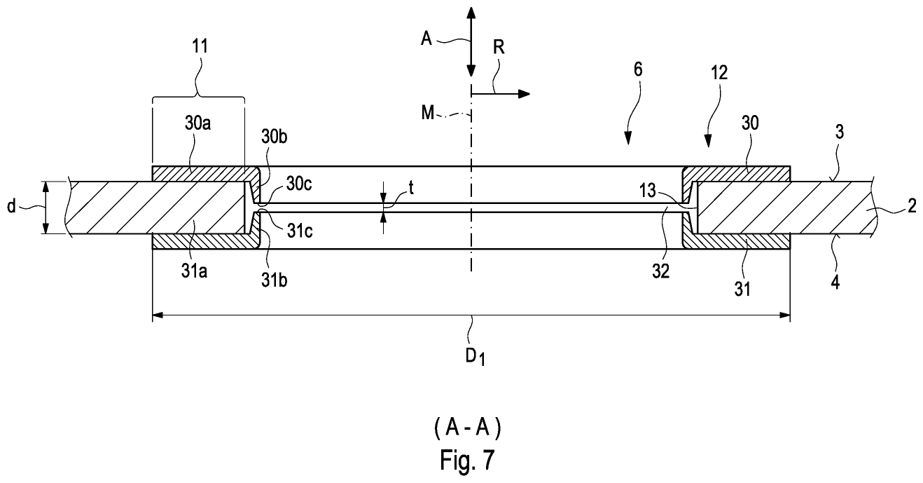

In another embodiment (FIG. 7), the intermediate layer 12 is composed of two structurally identical half-sleeve elements 30, 31. Each of the half-sleeve elements 30, 31 has a radial section 30a, 31a and an axial section 30b and 31b. The radial sections 30a, 31a respectively form shrouds and cover the surrounding region 11 around the fastening opening 6 of the shielding layer 2 on the latter's outer sides 3, 4. The axial sections 30b and 31b of the half-sleeve elements 30, 31 respectively have free ends 30c and 31c, which are positioned facing each other viewed in the axial direction A. The free ends 30c, 31c can contact each other or be spaced apart from each other in the axial direction A so that a gap 32 is formed between the free ends 30c and 31c.

The gap 32 has an axial span t that is smaller than a thickness d of the shielding layer 2 in the surrounding region 11. The decoupling element 10 to be mounted subsequently, for example the one-piece or multi-piece decoupling element 10 according to the embodiments in FIGS. 2 and 3, is used to fix the half-sleeve elements 30, 31 in the axial direction. The gap 32 also ensures that the radial sections 30a, 31a of the intermediate layer 12 embodied in this way rest on the outer sides 3, 4 of the shielding layer 2 without play in the axial direction A.

In the embodiment of the intermediate layer 12 according to FIG. 7, it is particularly advantageous that two structurally identical half-sleeve elements 30, 31 can be used to form the intermediate layer 12, thus reducing the number of parts required to form a shielding part 1 according to the invention.

As an alternative to the assembly of the half-sleeve elements 30, 31 so that they form the gap 32 as described above, it is also possible for the half-sleeve elements 30, 31 to be connected to each other, for example in the region of their free ends 30c and 31c. In addition, in the embodiments of the intermediate layer 12 according to FIGS. 4 and 6, instead of a fixed connection of the half-sleeves 15, 16 (embodiment according to FIG. 4) or a fixed connection of the half-sleeve element 25 and the disc element 26 (embodiment according to FIG. 5), it is also possible for these not to be connected to one another, but instead for an axial fixing of the above-mentioned elements relative to the shielding layer 2 to be produced by means of the decoupling elements 10.

The embodiments of the intermediate layers 12 according to FIGS. 4 to 7 are suitable according to the invention for forming a shielding part according to FIGS. 1, 2, and 3. Only for the sake of clarity, the sleeve body 8 and the decoupling element 10 and/or the metal wire ring structures 20, 21 are not shown in the drawings of the embodiments according to FIGS. 4 to 7.

The shielding part 1 can be embodied in a single layer composed of a shielding layer 2. Nevertheless, it is also possible to embody the shielding part 1 of multiple layers composed of a plurality of shielding layers 2. A shielding part 1 according to the invention can also have a thermally insulating and/or acoustically damping intermediate layer made of a non-metallic material, wherein the intermediate layer is preferably positioned between two shielding layers 2. The shielding layers 2 can be closed sheet metal layers. Particularly in combination with a closed sheet metal layer, an additional shielding layer 2 can have openings, for example a plurality of openings distributed over the planar expanse of the shielding layer 2. The shielding layers are preferably made of a metal material such as aluminum, steel, or stainless steel. Likewise, the sleeve body is preferably made of a metal, in particular a steel material.

1. A shielding part, in particular a heat shield, comprising:
at least one shielding layer with at least one fastening opening through which a fastener for fastening the shielding part to a fastening partner part can be inserted,
wherein the fastener is coupled to the shielding layer with regard to an axial and/or radial force transmission to the shielding layer and from the shielding layer to the fastener via at least one decoupling element,
wherein the at least one decoupling element is composed of a metal wire and cooperates with a surrounding region around the fastening opening on opposite outer sides of the shielding layer and/or with a frontal hole edge of the fastening opening of the shielding layer, and
at least one intermediate layer if; positioned between the decoupling element and the outer sides of the shielding layer and between the at least one decoupling element and the frontal hole edge of the fastening opening of the shielding layer.

2. The shielding part according to claim 1, wherein the intermediate layer is made of the same material as the metal wire of the at least one decoupling element or is made of a material that is harder than the material of the metal wire.

3. The shielding part according to claim 1, wherein the intermediate layer is supported without radial or axial play with respect to the shielding layer.

4. The shielding part according to claim 1, wherein the intermediate layer is composed of first and second half-sleeves axially inserted into each other, wherein each of the first and second half-sleeves has an axially extending axial section for cooperating with the other of the first and second half-sleeves and a circumferential shroud extending radially from the axial section, wherein one of the axial sections rests radially against an inside of the frontal hole edge and the first and second shrouds of the first and second half-sleeves rest against the outer sides of the shielding layer.

5. The shielding part according to claim 1, characterized in that wherein the at least one decoupling element is embodied of one piece and has an insertion opening for the fastener.

6. The shielding part according to claim 5, wherein a sleeve body is positioned in the insertion opening, wherein the sleeve body is made of a solid material that is more resistant to deformation than the at least one decoupling element.

7. The shielding part according to claim 4, wherein the first and second half-sleeves are crimped in a connecting region so that a form-fitting or frictional engagement is produced between the first and second half-sleeves.

8. The shielding part according to claim 1, wherein the intermediate layer and the metal wire of the at least one decoupling element are made of a stainless steel.

9. The shielding part according to claim 1, wherein the intermediate layer is embodied as a single-layer circumferential bead around a frontal hole edge.

10. The shielding part according to claim 1, wherein in a preassembly stage, the intermediate layer is positioned with a radial play up to 0.3 mm, and with an axial play up to 0.3 mm, with respect to the fastening opening in the shielding layer, and by moans of through radial expansion and axial squeezing of the intermediate layer, the intermediate layer rests without play against the frontal hole edge and against the outer sides.

11. The shielding part according to claim 1, wherein an outer diameter of the intermediate layer is greater than an outer diameter of the at least one decoupling element.

12. The shielding part according to claim 1, characterized in that wherein the intermediate layer has a material thickness of 0.2 to 0.6 mm.

13. The shielding part according to claim 1, wherein the at least one decoupling element is embodied of one piece comprising a metal wire structure and a connecting region surrounding the outer sides and the frontal hole edge.

14. The shielding part according to claim 4, wherein the at least one decoupling element is embodied of two or more parts comprising at least two metal wire structures, wherein a first metal wire structure is placed against the first shroud of the intermediate layer and a second metal wire structure is placed against the second shroud of the intermediate layer.

15. The shielding part according to claim 1, wherein the at least one decoupling element is prestressed in an axial direction of the fastening opening so that the shielding layer together with the intermediate layer cooperates with the at least one decoupling element in an axially clamped manner.

16. The shielding part according to claim 1, wherein the intermediate layer is composed of a half-sleeve element and a disc element.

17. The shielding part according to claim 1, wherein the intermediate layer is composed of two structurally identical half-sleeve elements.

18. The shielding part according to claim 17, wherein the half-sleeve elements each have an axial section that forms a gap between the axial sections in an assembled state, wherein an axial span of the gap is smaller than a thickness of the shielding layer.
